(19) United States
(12) Patent Application Publication
(10) Pub. No.: US 2019/0128344 A1
(43) Pub. Date: May 2, 2019

(54) CENTRIFUGAL CLUTCH WITH FRICTION-MINIMIZED COUPLING PIN AND DRIVETRAIN

(71) Applicant: Schaeffler Technologies AG & Co. KG, Herzogenaurach (DE)

(72) Inventor: Sebastian Heuberger, Bühl (DE)

(73) Assignee: Schaeffler Technologies AG & Co. KG, Herzogenaurach (DE)

(21) Appl. No.: 16/097,920

(22) PCT Filed: May 10, 2017
(86) PCT No.: PCT/DE2017/100398

§ 371 Date: Oct. 31, 2018

(30) Foreign Application Priority Data
Jun. 23, 2016 (DE) 10 2016 211 217.1

(51) Int. Cl. F16D 43/08; F16D 13/52

(52) U.S. Cl. CPC F16D 43/08; F16D 13/52

(57) ABSTRACT

A centrifugal clutch includes an angle plate, an inner basket, a pre-stressing element, and a coupling pin. The angle plate has an elongated hole and a loading section with a first side. The coupling pin is inserted into the elongated hole. A pre-stressing element stop is attached to the pre-stressing element and a coupling pin stop is attached to the coupling pin. The coupling pin is arranged to at least partially transmit axial movement of the angle plate to the inner basket. In an intermediate operating position, a relative movement between the angle plate and the coupling pin is possible when the inner basket rotates relative to the angle plate, and the coupling pin stop is matched to the pre-stressing element stop and the loading section so that the first side of the loading section has a maximum contact area to transmit a force to the pre-stressing element.

### CROSS-REFERENCE TO RELATED APPLICATIONS

This application is the United States National Phase of PCT Appln. No. PCT/DE2017/100398 filed May 10, 2017, which claims priority to German Application No. DE102016211217.1 filed Jun. 23, 2016, the entire disclosures of which are incorporated by reference herein.

### TECHNICAL FIELD

The present disclosure relates to a centrifugal clutch for a drivetrain of a motor vehicle, having a centrifugal mass that is coupled to an angle plate in such a way that a radial movement of the centrifugal mass caused by a centrifugal force causes an axial movement of the angle plate. The centrifugal clutch has a pre-stressing element that is assigned to a coupling pin, which is prepared to at least partially transmit the axial movement of the angle plate to an inner basket designed to hold laminae, and which is inserted into an elongated hole in the angle plate in such a way that in an intermediate operating position a relative movement between the angle plate and the coupling pin is made possible when the inner basket rotates relative to the angle plate. The coupling pin may be at least partially surrounded by the pre-stressing element.

### BACKGROUND

Various centrifugal clutches are known from the prior art. International patent application publication no. WO 2015/135540 A1 discloses a centrifugal clutch having an input part firmly attached to the motor, which is connected to laminae that come into contact with an output part by means of a centrifugal mass in such a way that a torque is transmissible from a motor output shaft to a transmission input shaft.

In centrifugal clutches according to this species, coupling is brought about depending on a speed of rotation. A first centrifugal mass is coupled here with a component attached to the motor, in such a way that a centrifugal force causes an axial movement of a first angle plate. Positioned between the first angle plate and a component attached to the transmission is a thrust bearing, which prevents rotational motion from being transmitted between the first angle plate and the component attached to the transmission. The axial movement of the first angle plate brought about by the first centrifugal mass, on the other hand, is transmitted to the component attached to the transmission. The component attached to the transmission is coupled rigidly to a second angle plate. The latter transmits the axial movement through a coupling pin to an inner basket, on which laminae are arranged, so that the inner basket laminae transmit torque frictionally with outer basket laminae that are connected non-rotatingly to the component attached to the motor. The torque of the inner basket is passed on via leaf springs to a hub, which provides the rotational speed of the transmission input shaft.

The coupling pin is surrounded by a pre-stressing element, so that an additional axial movement caused by a second centrifugal mass, which, analogously to the first centrifugal mass, brings about an axial movement of the second angle plate that intensifies the frictional lock between the laminae, is intercepted in such a case by the pre-stressing element if the force in the laminae should become too great. Because of its inertia, the second centrifugal mass causes a disengagement of the centrifugal clutch to be delayed, whereas an engagement is possible even with low torque and high rotational speeds.

The centrifugal clutches known from the prior art have the disadvantage that when the clutch is in a non-stationary state, for example in a moving-off process, unwanted frictional forces arise due to relative movements of individual components.

Furthermore, in the prior art the pre-stressing elements are coupled to an angle plate in such a way that the entire pre-stressing force of the pre-stressing element acts on the coupling zone between the pre-stressing element and angle plate when the inner basket is in a state of motion relative to the angle plate.

### SUMMARY

In the intermediate operating position, a loading section of the angle plate provided to transmit force to the pre-stressing element, a stop attached to the coupling pin and a stop attached to the pre-stressing element, are matched to each other so that the angle plate has a maximum contact area on one side of its loading section to transmit force. In this way, the pre-stressing element, which may be designed as a compression spring, acts on the angle plate on one side, which minimizes the occurrence of friction forces.

Example embodiments will be explained in greater detail below.

The contact area may be formed on the side of the angle plate facing the pre-stressing element. This provides space benefits, since the pre-stressing element is positioned at the shortest distance from the angle plate. In this way, the side of the angle plate facing away from the pre-stressing element experiences no pressure force from the side of the pre-stressing element, which further favors the intended minimization of friction.

When the pre-stressing element and the coupling pin are configured so that the movement of the coupling pin relative to the angle plate is achievable free of any pre-stressing of the pre-stressing element, a leaf spring positioned between the inner basket and a hub exerts a pressure force on the angle plate when a relative movement occurs between the inner basket and the angle plate.

The pre-stressing force exerted by the leaf spring is less than that exerted by the pre-stressing element. In this way, it is possible to reduce the friction that occurs in the relative rotation.

In an example embodiment, the stop attached to the coupling pin is formed by a support plate, which is attached rigidly to the coupling pin by a fastener such as a screw. In this way, a conventional coupling pin can be used. Attaching the additional support plate is sufficient to achieve the benefits according to the disclosure.

When the stop attached to the pre-stressing element is formed by an intermediate plate which can be placed on the pre-stressing element, a time-efficient and economical assembly of the coupling pin according to the disclosure with the pre-stressing element is possible. Furthermore, the geometry and material composition of the intermediate plate may be designed so that it can absorb the forces which act between the pre-stressing element, the coupling pin and the angle plate in a way that optimizes the flow of force.

It may be advantageous if an application of force brought about by the pre-stressing element acts on one side of the angle plate. A unilateral application of force brings the advantage that no opposing force is inducible. A corresponding relative rotation, which is enabled by a unilateral application of force, is accordingly lower in friction than a bilateral application of force. This prevents a clamping of the angle plate between two sections, each of which is pre-stressed by the pre-stressing element. Besides a lower energy input, caused by the relative rotation, the benefit of longer service life is realized. The reduced friction implies less abrasion of the angle plate, which on the one hand prolongs its life, and on the other hand causes fewer particles/shavings in the clutch. This also increases the quietness of operation of the centrifugal clutch according to the disclosure.

In an example embodiment, the angle plate and the coupling pin are connected to each other in such a way that the coupling pin allows a movement of the angle plate in a direction away from the coupling pin. The axial movement of the angle plate in the direction away from the coupling pin is limited accordingly by other components of the centrifugal clutch.

Additionally, it may be advantageous if the stop attached to the coupling pin is formed by a fastener that is connected rigidly to the coupling pin. The rigid connection keeps the relative friction low even at high vibrations, which has a positive affect on the life of the centrifugal clutch.

In addition, it may be advantageous if the coupling pin is designed as a stepped rivet. On the one hand, stepped rivets can be produced as standard components and at a reasonable price; on the other hand, they have shoulders which excel as a reliable stop in the centrifugal clutch.

According to the present disclosure, a drivetrain of a motor vehicle is disclosed. The drivetrain has a motor, a clutch and a transmission, the clutch being produced according to the design of a centrifugal clutch presented above.

In other words, an angle plate, which is positioned on the transmission side of a first centrifugal mass in the axial direction, is moved axially in the direction of the transmission by a first and/or second centrifugal mass. The centrifugal masses are designed here so that they bring about a coupling between the motor output shaft and the transmission input shaft even at a low speed of rotation. Thus, even at low rotational speeds they produce a motor torque that suffices to propel a motor vehicle. Since a coupling occurs even at low rotational speeds, it follows that at high rotational speeds the axial force induced by the centrifugal masses may be greater than necessary. To compensate for the excessive application of force, a pre-stressing element is employed to limit the pressing force and/or the disengaging force. The pre-stressing element may be designed as a compression spring, which is pre-stressed to the maximum pressing force. If a force is induced by the centrifugal masses that is greater than the pre-stressing of the compression spring, the compression spring is compressed. The centrifugal masses may be limited by a stop. Furthermore, the inner basket of the centrifugal clutch is linked to a hub by means of leaf springs, which brings about an additional intensification of the pressing force. The greater the axial movement of a leaf spring, the greater the rotation of the inner basket.

According to the disclosure, the operating area between the angle plate, the pre-stressing element and the coupling pin is designed so that they transmit force at a friction point. Thus, at the friction contact between the angle plate and the component attached to the pre-stressing element, e.g., a washer, the only force present is the stiffness of the leaf spring.

The centrifugal clutch according to the disclosure may be designed as a multi-plate clutch. It lends itself primarily for use in motorcycles, automobiles, dual clutches and/or hybrid clutches. While a wet-running clutch is also possible, dry clutch operation is preferred here.

According to the disclosure, the fuel consumption of a vehicle may be reduced. The division of the centrifugal masses according to the disclosure into a motor side and a transmission side also enables earlier synchronization of the clutch, which makes it possible to drive/drive off at lower motor speeds. The effect of this is that carbon dioxide emissions are significantly reduced for applications with centrifugal clutches according to the disclosure.

The division of the centrifugal masses according to the disclosure, namely into a motor and a transmission side, also makes a driving experience possible whose performance is very similar to that of conventional drivetrains. In particular, a motor under full load may be operated at lower speeds without causing slippage in the clutch. In combination with the self-intensification as a centrifugal disk, the solution according to the disclosure may thus be utilized for all conventional applications, i.e., also for shift transmissions without a centrifugal clutch, without necessitating an adaptation of the vehicle architecture. This expands the range of application of the device according to the disclosure.

In summary, the rotation of the inner basket or load transfer cup in the disengaging behavior is improved by inserting washers on the pin on the inner basket or load transfer cup side, which are positioned between the coil springs and the plate piece or ramp plate in the axial direction.

### BRIEF DESCRIPTION OF THE DRAWINGS

Example embodiments will be explained in greater detail below by means of figures. The figures show the following:

FIG. 1 shows a perspective longitudinal section through a centrifugal clutch according to the disclosure;

FIG. 2 shows a longitudinal sectional view of the centrifugal clutch;

FIG. 3 shows a coupling pin according to the disclosure in enlarged view; and

FIG. 4 shows an angle plate according to the disclosure in top view.

### DETAILED DESCRIPTION

The figures are merely schematic in nature, and serve to aid in understanding the disclosure. The same elements are provided with the same reference labels. The features of the individual exemplary embodiments may be exchanged with one another.

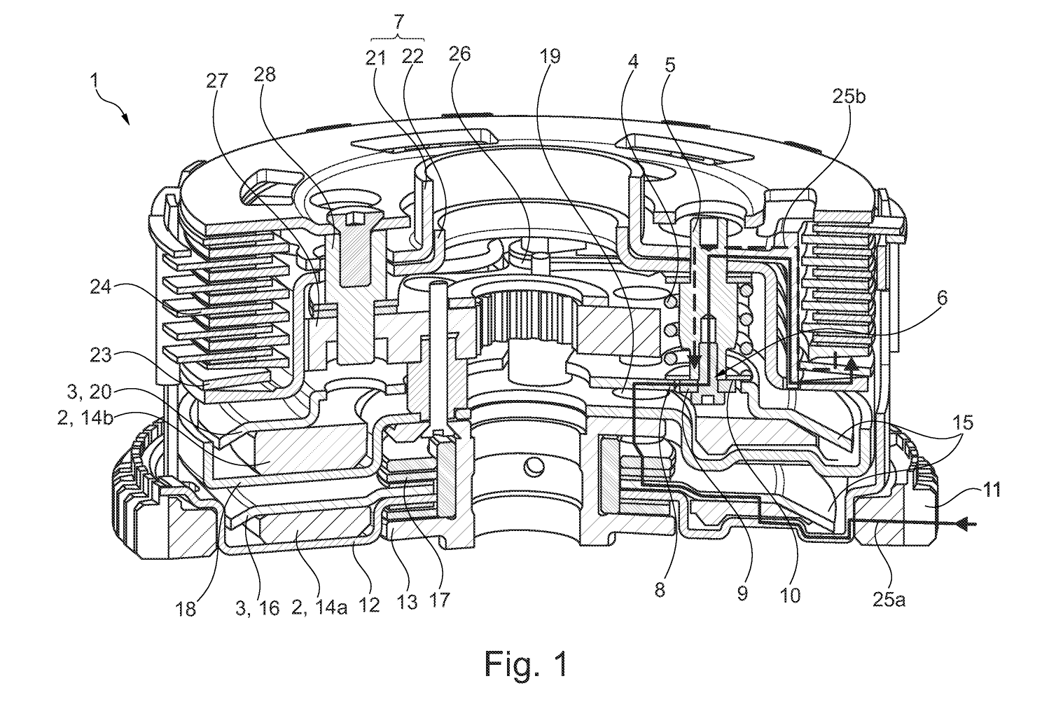

FIG. 1 depicts a centrifugal clutch. The centrifugal clutch 1 has a centrifugal mass 2, which is operatively connected to an angle plate 3. Furthermore, the centrifugal clutch 1 has a coupling pin 5 surrounded by a pre-stressing element 4. An elongated hole 6 makes a certain relative rotation between an inner basket 7 and the angle plate 3 possible. In order for force to be transmissible from the pre-stressing element 4 to the angle plate 3, the angle plate 3 has a loading section 8. Furthermore, to transmit force between the pre-stressing element 4 and the angle plate 3 a stop 9 is attached firmly to the coupling pin, as well as a stop 10 attached firmly to the pre-stressing element.

Force is introduced into the friction clutch 1 by means of a ring gear 11. The latter is connected non-rotatingly to the input part 12. Between the input part 12 and a first shaft 13, a thrust bearing is positioned so that the input part 12 and the first shaft 13 are rotatable relative to each other. A first centrifugal mass 14a is coupled with the input part 13 so that it is fixed in the circumferential direction and variable in the radial direction. A second centrifugal mass 14b is positioned to the transmission side of the first centrifugal mass 14a. Due to a bevel 15 on a first angle plate 16, the radial movement of the first centrifugal mass caused by the centrifugal force is converted to an axial movement of the first angle plate 16. A thrust bearing 17 prevents rotation from being transmitted from the first angle plate 16 to a centrifugal mass carrier part 18.

A connecting piece 19 ensures that the axial movement of the first angle plate is transmitted to a second angle plate 20. According to the disclosure, the coupling pin 5 is coupled with the second angle plate 20 in such a way that, in a state in which the maximum pressing force pre-stressed by the pre-stressing element is not reached, the axial movement of the second angle plate results in an axial movement of the inner basket 7. The inner basket is made up of a driver 21 and a load transfer cup 22. A contact segment 23 of the inner basket 7 causes laminae 24 to be pressed against one another in such a way that a torque is transmissible from the motor side to the transmission.

The frictional lock referenced by the arrow 25a in FIG. 1 represents the flow of force resulting from the clamping of the laminae 24. The frictional lock referenced by the label 25b is that which transmits the rotation from the inner basket 7 to the second angle plate 20. A relative rotation can occur here, due to the geometry of the elongated hole 6. According to the disclosure, friction occurs here between the stop 10 attached to the pre-stressing element and the loading section 8. According to the disclosure, this friction is determined by the pre-stressing of a leaf spring 26.

When the inner basket 7 rotates, a rotation is transmitted via the leaf spring 26 to the hub 27. The hub 27 drives the transmission input shaft. The hub 27 is connected rigidly to a housing part 29 by means of a bolt 28.

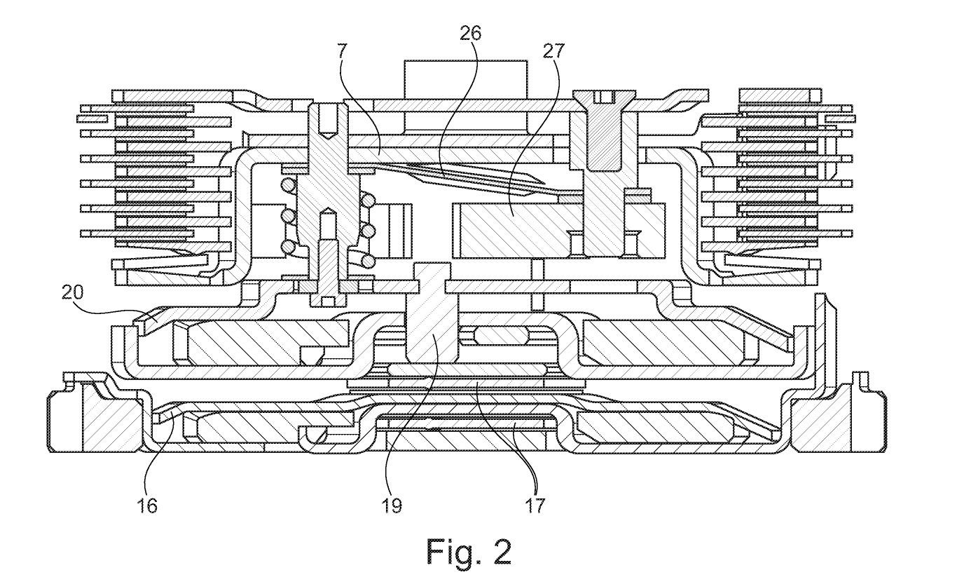

FIG. 2 depicts a sectional view of the component presented above. Here, the connection between the leaf spring 26 and the hub 27 as well as the inner basket 7 is clearly evident. Also shown is the connecting piece 19, which couples the first angle plate 16 axially rigidly with the second angle plate 20. The thrust bearings 17 prevent rotation from being transmitted from the first angle plate 16 to the second angle plate 20.

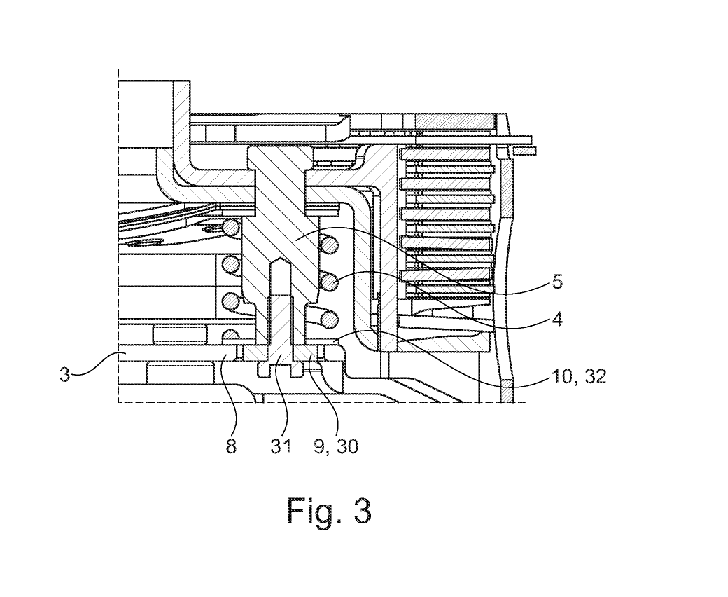

FIG. 3 shows an enlarged depiction of the coupling pin 5 according to the disclosure, in the installed state. The pre-stressing element 4 surrounds the coupling pin 5. The stop 9 attached to the coupling pin is formed by a supporting plate 30. The supporting plate 30, in turn, is attached rigidly to the coupling pin 5 by means of a fastening element 31. An operative connection is produced between the loading section 8 of the angle plate 3 and the supporting plate 30 by means of the stop 10 attached to the pre-stressing element. In the present example, the stop 10 attached to the pre-stressing element is designed as an intermediate plate 32.

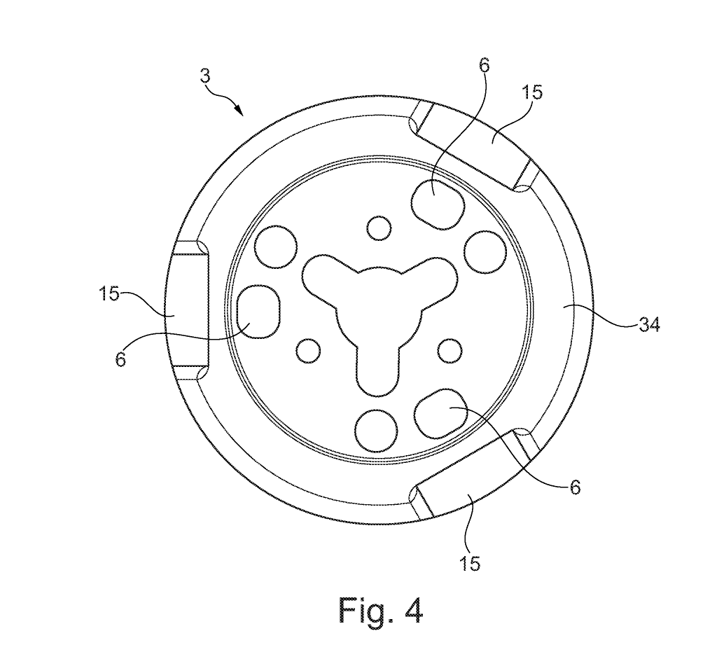

FIG. 4 shows a top view of an angle plate 3 according to the disclosure. The bevel 15 is located here at three positions in the circumferential direction. It causes an axial movement of the angle plate 3 when a centrifugal mass 3 is moved in the radial direction. The angle plate 3 has various openings. Besides the central opening 33, the elongated holes 6 are of primary relevance according to the disclosure. The coupling pin 5 is positioned in these. The top view shows the angle plate 3 with its side 34 facing the transmission.

### REFERENCE LABELS

1 centrifugal clutch
2 centrifugal mass
3 angle plate
4 pre-stressing element
5 coupling pin
6 elongated hole
7 inner basket
8 loading section
9 stop attached to the coupling pin
10 stop attached to the pre-stressing element
11 ring gear
12 input part
13 shaft
14a first centrifugal mass
14b second centrifugal mass
15 bevel
16 first angle plate
17 thrust bearing
18 centrifugal mass carrier part
19 connecting piece
20 second angle plate
21 driver
22 cup-shaped load transfer plate
23 contact segment
24 lamellae
25a first flow of force
25b second flow of force
26 leaf spring
27 hub
28 bolt
29 housing part
30 supporting plate
31 fastening element
32 intermediate plate
33 central opening
34 side facing the transmission

1.-10. (canceled)

11. A centrifugal clutch for a drivetrain of a motor vehicle comprising:
an angle plate comprising an elongated hole and a loading section with a first side;
a centrifugal mass;
an inner basket for holding laminae;
a pre-stressing element;
a pre-stressing element stop attached to the pre-stressing element;
a coupling pin, at least partially surrounded by the pre-stressing element, inserted into the elongated hole;
a coupling pin stop attached to the coupling pin;
wherein:
the centrifugal mass is coupled to the angle plate such that a radial movement of the centrifugal mass from a centrifugal force axially moves the angle plate;
the coupling pin is arranged to at least partially transmit axial movement of the angle plate to the inner basket; and,
in an intermediate operating position:
a relative movement between the angle plate and the coupling pin is possible when the inner basket rotates relative to the angle plate; and,
the coupling pin stop is matched to the pre-stressing element stop and the loading section so that the first side of the loading section has a maximum contact area to transmit a force to the pre-stressing element.

12. The centrifugal clutch of claim 11 wherein the first side faces the pre-stressing element.

13. The centrifugal clutch of claim 12 wherein the relative movement between the angle plate and the coupling pin is free of any pre-stressing of the pre-stressing element.

14. The centrifugal clutch of claim 11 wherein the coupling pin stop is a support plate rigidly attached to the coupling pin by a fastener.

15. The centrifugal clutch of claim 14 wherein the pre-stressing element stop is an intermediate plate placed on the coupling pin between the pre-stressing element and the coupling pin stop.

16. The centrifugal clutch of claim 11 wherein a force introduced by the pre-stressing element operates on the first side of the loading section of the angle plate.

17. The centrifugal clutch of claim 11 wherein the angle plate and the coupling pin are coupled to each other such that the coupling pin allows a movement of the angle plate in a direction away from the coupling pin.

18. The centrifugal clutch of claim 11 wherein the coupling pin stop is formed by a fastener rigidly connected to the coupling pin.

19. The centrifugal clutch of claim 11 wherein the coupling pin is a stepped rivet.

20. A drivetrain of a motor vehicle comprising:
a motor;
the centrifugal clutch of claim 11; and,
a transmission.

21. A centrifugal clutch comprising:
a first radially displaceable centrifugal mass comprising a first conical surface;
a first angle plate comprising a second conical surface in contact with the first conical surface;
a second angle plate comprising an elongated hole with a first diameter;
a connecting piece, fixed to the second angle plate, for transmitting an axial force from the first angle plate to the second angle plate;
an inner basket drivingly engaged with a plurality of laminae; and,
a coupling pin comprising a first distal end fixed to the inner basket and a second distal end disposed proximate the elongated hole and comprising a second diameter less than the first diameter.

22. The centrifugal clutch of claim 21 further comprising a compression spring installed on the coupling pin between the second angle plate and the inner basket.

23. The centrifugal clutch of claim 22 further comprising a first stop fixed to the second distal end of the coupling pin and comprising a third diameter less than the first diameter and greater than the second diameter.

24. The centrifugal clutch of claim 23 further comprising a second stop installed on the coupling pin between the compression spring and the first stop.

25. The centrifugal clutch of claim 24 wherein the second stop comprises a fourth diameter greater than the first diameter.

26. The centrifugal clutch of claim 24 wherein the second stop is installed on the coupling pin between the second angle plate and the compression spring.

27. The centrifugal clutch of claim 21 further comprising a second radially displaceable centrifugal mass with a third conical surface, wherein the second angle plate comprises a fourth conical surface in contact with the third conical surface.

28. The centrifugal clutch of claim 21 further comprising:
a hub arranged for driving engagement with a transmission shaft; and,
a leaf spring comprising a first end fixed to the hub and a second end fixed to the inner basket by the coupling pin.

29. The centrifugal clutch of claim 21 wherein the second distal end of the coupling pin is axially displaceable relative to the second angle plate.

30. The centrifugal clutch of claim 21 further comprising a contact segment arranged to clamp the plurality of laminae when the first radially displaceable centrifugal mass moves radially outward and axially displaces the first angle plate.
